(19) United States
(12) Patent Application Publication
(10) Pub. No.: US 2003/0203662 A1
(43) Pub. Date: Oct. 30, 2003

(54) Connector structure for computer flat-cable

(75) Inventor: Hu-Min Liu, Hsinchu (TW)

Correspondence Address: DOUGHERTY & TROXELL, 5205 LEESBURG PIKE, SUITE 1404, FALLS CHURCH, VA, 22041, US

(73) Assignee: MITAC INTERNATIONAL CORP.

(21) Appl. No.: 10/128,485

(22) Filed: Apr. 24, 2002

(51) Int. Cl. H01R 12/00

(52) U.S. Cl. 439/67

(57) ABSTRACT

A connector structure for computer flat-cable, which is applied on an upper portion of a soft flat-cable usually used in a hard disc driver or a CD-ROM driver arranged in a computer and is adapted as a connection device between the mother board and the hard disc driver or the CD-ROM driver. An embodiment of the present invention is to arrange a short pin in the 28^{th} penetration hole of the main body of the connector to make the short pin of the connector unable to penetrate through the soft flat-cable and form an open circuit between the 28^{th} penetration hole of the connector and the judgement signal line for distinguishing a first drive and a second drive for the hard disc driver or the CD-ROM driver, for example. Another embodiment of the present invention is to cut out a lower portion of a long pin arranged in the 28^{th} penetration hole of the main body of the connector to make it become a short pin, so that the short pin of the connector can not penetrate through the soft flat-cable and is formed as an open circuit between the 28^{th} penetration hole of the connector and the judgement signal line and is used for distinguishing a first drive and a second drive for the hard disc driver or the CD-ROM driver, for example.

### FIELD OF THE INVENTION

The invention relates to a connector structure for computer flat-cable, more particularly, to a connection device applied on an upper portion of a soft flat-cable usually used in a hard disc or CD-ROM driver arranged in a computer, so that it may connect the mother board and the hard disc driver or the CD-ROM driver.

### BACKGROUND OF THE INVENTION

Accordingly, the industry of computer is developing fast and vigorously and matched with the application of multimedia and network, the operation circumstance of computer is switched from the monotony into the wide and colorful world. Following the application of computer multimedia, the auxiliaries developed from computer are more and more, so the connectors corresponding to the computer are also more and more relatively and the patents relative to the connector of computer are numerous.

Please refer to FIG. 1, which is a prior U.S. Pat. No. 6,058,604 titled “A Cable for Allowing Mass Storage Device Address Selection”. In this US patent, it disclosed a soft flat-cable 1 usually used in the hard disc driver or the CD-ROM driver of computer. At two ends and appropriate middle positions of the soft flat-cable 1, each is arranged with a connector 2, 3, 4. By penetrating plural pins under the connectors 2, 3, 4 into the soft flat-cable 1, the connectors are fixed above the soft flat-cable 1 as an electric connection. In order to respond and judge when more than two CD-ROM drivers or hard discs are mounted on a soft flat-cable 1 for distinguishing a first drive and a second drive, it must get rid of the 28^{th} CSEL pin located at the middle connector 3 or the 28^{th} CSEL pin located at the right connector 4 so as to form a state of open circuit between the 28^{th} CSEL pin and the soft flat-cable 1. Please refer to FIG. 2, in which a clipping board 14 is arranged at the upper portion of the soft flat-cable 1. Under the soft flat-cable 1, an electric connection is formed by penetrating through plural CSEL pins of the connector 3. However, when the connector 3 is under production, the penetration hole 34 of the 28^{th} CSEL pin must be penetrated through by the stamping manner, such that the internal diameter of the penetration hole 34 is made to be larger than the exterior of the CSEL pin to make its interior unable to accommodate any CSEL pin. When this sort of manufacturing process is applied, it is easy to cause a damage on the penetration hole 34 of the connector 3 due to the stamping strength, and this is the biggest shortcoming of the prior arts, which will be overcome by the present invention.

### SUMMARY OF THE INVENTION

In the prior arts, it must get rid of the 28^{th} CSEL pin of the connector of the flat-cable and the penetration hole of the 28^{th} CSEL pin is penetrated through by the stamping manner to make the internal diameter of the penetration hole is larger than the exterior of the CSEL pin and make its interior unable to accommodate any CSEL pin, but it creates a shortcoming that the connector is easily damaged. Through the conception and research of the inventor, a connector of novel structure is invented. When a soft flat-cable is mounted with more than two CD-ROM drivers or hard disc drivers, it can accurately judge and distinguish the device to the first drive and the second drive.

The main objective of the invention is to arrange a short pin in the 28^{th} penetration hole of the main body of the connector. The short pin of the connector is made to be unable to penetrate through the soft flat-cable, so that an open circuit is formed between the 28^{th} penetration hole of the connector and the judgement signal line and, therefore, a first drive and a second drive of the hard disc driver or the CD-ROM driver, etc. are distinguished.

Another objective of the invention is to cut out the pin leg under the long pin arranged in the 28^{th} penetration hole of the main body of the connector to make it become a short pin, such that the short pin of the connector will not penetrate through the soft flat-cable and, therefore an open circuit is formed between the 28^{th} penetration hole of the connector and judgement signal line to distinguish a first drive and a second drive for the hard disc driver or the CD-ROM driver, etc.

For your esteemed reviewing committee members to further recognize and understand the invention in more complete way, a detailed description of the invention in matching with corresponding drawings are presented as following and hope they will benefit your esteemed reviewing committee members in reviewing this patent application favorably.

### BRIEF DESCRIPTION OF THE DRAWINGS

FIG. 1 is a structural illustration for a soft flat-cable according to the prior arts for connecting a CD-ROM driver or hard disc driver arranged on a computer.

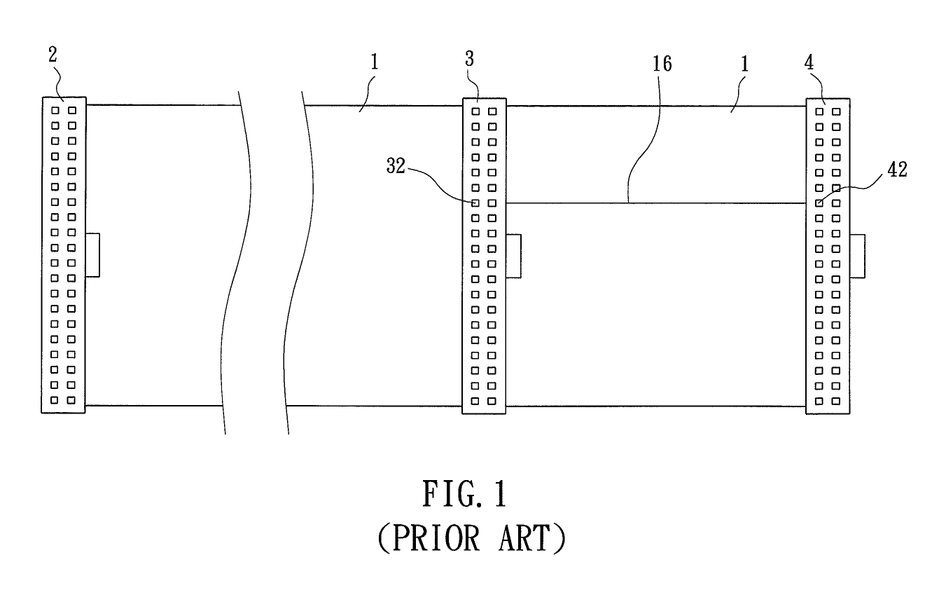

FIG. 2 is a structural illustration for a connector according to prior arts, in which the 28^{th} penetration hole is not arranged with any CSEL pin.

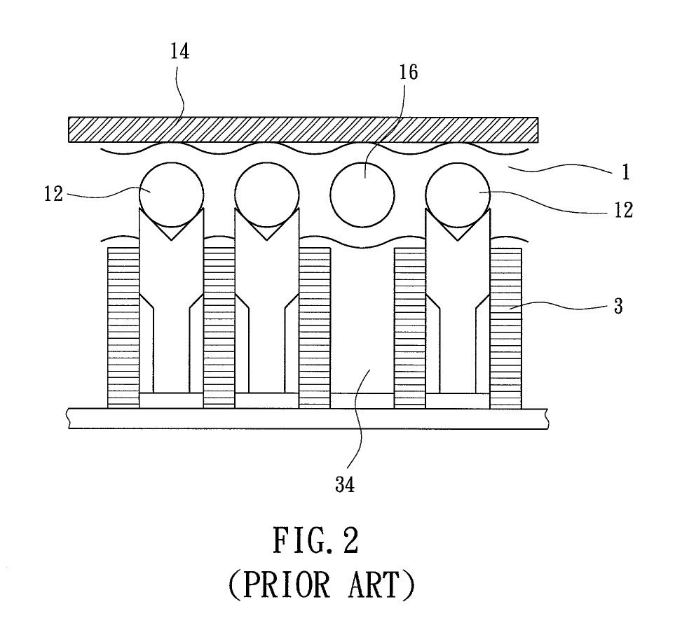

FIG. 3 is a structural illustration for a connector according to the invention, in which the 28^{th} penetration hole is arranged with a short pin.

### DETAILED DESCRIPTION OF THE INVENTION

Matched with corresponding drawings, the preferable embodiments of the invention are presented as following.

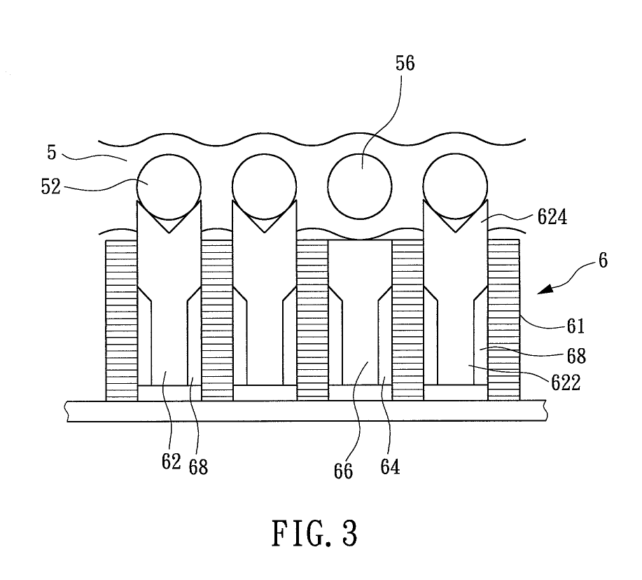

Please refer to FIG. 3, which is a structural illustration for a connector according to the invention, in which the 28^{th} penetration hole is arranged with a short pin. There are two kinds of embodiments to form such structure, each will be described as follows.

1. The First Constituted Embodiment of the Connector.

The first embodiment of the connector includes a main body of connector 61, plural long pins 62, and a short pin 66, and the plural long pins 62 are arranged in the corresponding penetration holes 68 in the main body of connector 61, and the long pin 62 includes a contacting end 622 and a pin leg 624, and the pin leg 624 of the long pin 62 is made to be protruded outward under the main body of connector 61 for penetrating into the soft flat-cable 5 and contacting with the internal signal line 52 to make the connector 6 make an electric connection with the soft flat-line 5, but the 28^{th} penetration hole 64 is kept from being inserted any long pin 62, while the 28^{th} penetration hole of the main body of connector 61 is arranged with a short pin 66 to be formed as an open circuit between the short pin 66 in the 28^{th} penetration hole of the connector 6 and the judgement signal line 56 and be used as a distinguish of the first drive and the second drive for the hard disc driver or the CD-ROM driver, etc.

2. The Second Constituted Embodiment of the Connector.

The first embodiment of the connector includes a main body of connector 61, plural long pins 62, and a short pin 66, and the plural long pins 62 are arranged in the corresponding penetration holes 68 in the main body of connector 61, and the long pin 62 includes a contacting end 622 and a pin leg 624, and the pin leg 624 of the long pin 62 is made to be protruded outward under the main body of connector 61 for penetrating into the soft flat-cable 5 and contacting with the internal signal line 52 to make the connector 6 make an electric connection with the soft flat-line 5, and the pin leg 624 under the long pin 62 arranged in the 28^{th} penetration hole 64 of the main body 61 of the connector is cut out to become a short pin 66 to be formed as an open circuit between the short pin 66 in the 28^{th} penetration hole of the connector 6 and the judgement signal line 56 and be used as a distinguish of the first drive and the second drive for the hard disc driver or the CD-ROM driver, etc.

In summary, from the structural characteristics and detailed disclosure of each embodiment according to the invention, it sufficiently shows that the invention has progressiveness of deep implementation in both objective and function, also has the application value in industry, and it is an application never seen ever in current market and, according to the spirit of patent law, the invention is completely fulfilled the essential requirement of new typed patent.

However, the above description is only the preferable embodiment of the invention and can not be used as a limitation for the scope of implementation of the invention. Any variation and modification made from the scopes claimed from the invention all should be included within the scope of the present invention, and hope your esteemed reviewing committee member examine this application favorably and permit it as a patent wishfully.

What is claimed is:

1. A connector structure for computer flat-cable includes a main body of connector, plural long pins, and a short pin, and the plural long pins are arranged in the corresponding penetration holes in the main body of connector, and the pin leg of the long pin is made to be protruded outward under the main body of connector for penetrating into the soft flat-cable and contacting with the internal signal line to make the connector make an electric connection with the soft flat-line, but the 28^{th} penetration hole is kept from being inserted any long pin, and it is characterized that the 28^{th} penetration hole of the main body of connector is arranged with a short pin to be formed as an open circuit between the short pin in the 28^{th} penetration hole of the connector and the judgement signal line and be used as a distinguish of the first drive and the second drive for the hard disc driver or the CD-ROM driver, etc.

2. The connector structure for computer flat-cable according to claim 1, wherein the long pin includes a contacting end and a pin leg.

3. A connector structure for computer flat-cable includes a main body of connector, plural long pins, and a short pin, and the plural long pins are arranged in the corresponding penetration holes in the main body of connector, and the pin leg of the long pin is made to be protruded outward under the main body of connector for penetrating into the soft flat-cable and contacting with the internal signal line to make the connector make an electric connection with the soft flat-line, and it is characterized that the pin leg under the long pin arranged in the 28^{th} penetration hole of the main body of the connector is cut out to become a short pin to be formed as an open circuit between the short pin in the 28^{th} penetration hole of the connector and the judgement signal line and be used as a distinguish of the first drive and the second drive for the hard disc driver or the CD-ROM driver, etc.

4. The connector structure for computer flat-cable according to claim 3, wherein the long pin includes a contacting end and a pin leg.
